(19) United States
(12) Patent Application Publication
(10) Pub. No.: US 2008/0091954 A1
(43) Pub. Date: Apr. 17, 2008

(54) Method and system for facilitating printed page authentication, unique code generation and content integrity verification of documents

(76) Inventors: Daniel R. Morris, Virginia Beach, VA (US); Pratik D. Kotharl, Virginia Beach, VA (US); Ryan Andrew Steven Florin, Virginia Beach, VA (US)

Correspondence Address: WILLIAMS MULLEN, 222 CENTRAL PARK AVENUE, SUITE 1700, VIRGINIA BEACH, VA, 23462, US

(21) Appl. No.: 11/582,101

(22) Filed: Oct. 17, 2006

(51) Int. Cl. H04L 9/00; G06F 12/14; H04L 9/32; G06F 11/30

(52) U.S. Cl. 713/187; 713/176

(57) ABSTRACT

The present invention provides a system and method for facilitating authentication and data/content integrity verification of printed documents underlying legal transactions and other documents requiring durability, including real estate and loan transactions, for example. A Unique Content Identifier parses the document one page (or other pre-determined segment) at a time. Each segment of the document is assigned a digit or group of digits, and each page or document segment can be provided with a single digit in the overall identifier. The entirety of digits associated with a document is aggregated into an authentication string. Upon receiving a request to process the document later, the present invention can authenticate and verify the integrity of the document by reading the presented document to obtain an authentication string, and then compare the new string with the previously stored string. Upon a successful match, the document is considered valid, authenticated and unaltered.

### FIELD OF THE INVENTION

The present invention relates to the authentication of a printed document's integrity; more particularly, a system and method for processing financial, legal, and other printed documents for a later authentication of the integrity of the document's data/content.

### BACKGROUND

Computer security defines authentication as a process in which a computer, computer program or a user is, in fact, who or what they claim they are. Mathematicians and researchers, all over the world, have developed different mechanisms of authentication in this field. Digital signatures, challenge-response authentication, passwords, security tokens, fingerprints and retinal patterns are just a few of the numerous ways authentication is presently performed. Arguably, almost all of these methods have been developed to support the integrity and validation of digital documents only.

Protection of a document during an electronic transmission or when it is in its digital form has been a primary field of research in the domain of computer authentication and security. Now that there are so many word processing, imaging, and conversion software applications available, converting a printed document to an electronic form, modifying the sensitive content of the data and then converting this document back to its paper form can be very easily performed. There is presently no fool-proof solution to handle the problems caused by such digital document modification technologies. Although the world may be aiming towards paperless offices, it remains clear that industries like finance, insurance, banking, law, and several others, will continue to use printed documents for several generations to come. Throughout these industries, documents containing sensitive information are constantly printed, copied and faxed. Thus, authors of and parties to documents containing data and content requiring durability and protection from alteration, such as Journals, historical papers, or legal documents such as Promissory Notes, Deeds, Wills, Trust, etc., require a process to validate the content's integrity as originally approved by the author. Securing this information is the key to maintaining the integrity of these printed documents.

Document reproduction, signature forgery and/or slip sheeting are common methods of fraud or alteration. Although there are several methods available to the author to track and verify the content of an electronic transmission of documents, there is no current technology that captures the document(s) content upon the author's authorized conversion to printed copy.

For example, an attorney, as part of his or her profession, creates a legal document and hands it to the client, some agent, or responsible entity. Once the document is printed, the client or entity may either use the document or pass it on to another entity. It is not unusual for the printed document to change hands several times throughout its lifetime. These documents are susceptible to attacks of many kinds, e.g., when a sensitive element (say a word, an amount or a statement) is modified maliciously to distort the meaning of the document. In this legal example, the alteration may involve the agreed terms among the parties to a contract. In fact, given the easy accessibility of word processing software, and desktop publishing, a similar but altered document can be easily reproduced. In order to maintain the intent of the author, it becomes essential in many cases to prove the veracity of the document's content as authorized by the author. The following demonstrates some of these scenarios:

In the real estate transaction setting, the closing agent's or settlement agent's job is to coordinate, prepare, and record the closing documents on behalf of several parties (e.g. mortgage lender, title company, borrower, seller, real estate agent etc.), and then to disburse the funds. Attorneys, title companies or escrow companies usually conduct the closing. If the buyer in a real estate transaction obtains mortgage financing through a mortgage lender, then the mortgage lender might approve the closing agent after a “Purchase and Sales Agreement” is executed. The closing agent is usually engaged in a legal relationship with the lender (among other parties) in the transaction and generally will conduct the Title Search, Title Insurance, and Property Survey.

After closing, the closing agent will officially record the deed and the mortgage at the registry of deeds or local clerk's office. Disclosure forms can be generated in package form, to provide documentation establishing the relationship between the attorney and the buyer. In a web environment, the parties or settlement agent can click on an order form to generate documents for this relationship and the transaction.

Given all of the steps and documents involved in a real estate closing, and despite the various measures (e.g., title insurance, notary public authentication of signatures) taken to protect the transacting parties, numerous opportunities exist for less-than-honorable individuals to attempt to defraud the system and parties to the present transaction or future transactions. For example, a warranty deed is a legal document that includes the guarantee that the seller is the true owner of the property, has the right to sell the property, and ensures that there are no claims against the property. The terms of the Real Estate Purchase Agreement dictates a general warranty deed be prepared and delivered to the seller. Here, Seller agrees to defend title from all defects or claims. Seller has his attorney prepare a general warranty deed proposing to convey title to Buyer “WITH GENERAL WARRANTY AND ENGLISH COVENANTS OF TITLE”; however, Seller learns that his title contains a defect that would cost tens of thousand of dollars to cure. Seller simply redrafts the first page of the General Warranty Deed, replaces the conveyance language with “SPECIAL WARRANTY”, and replaces the original first page which was drafted and approved by his attorney. The simple replacement of the word “General” with “Special” has significant legal ramifications in many jurisdictions. Such a change would likely escape notice by the settlement agent after the signing/closing when the document is put to record. Many years later the title defect emerges and Buyer looks to Seller (or the Insurer of the Owner's Title Policy) to cure the defect. The question of which deed page was the approved printed document is critical in resolving the conflict.

Alternatively, a party may take a previously signed promissory note and add or change language to portions thereof to give him or herself more favorable rights. For example, a term requiring personal guarantee may be removed. Such forgeries and improper alterations can often be extremely difficult to detect, and even when foul play may be suspected, it is often difficult to prove the original content, or to compare differences in two different documents (the original and the maliciously modified document).

Another example of an alteration would be the change in a beneficiary of a Last Will and Testament or Trust. In such documents, the party who approved the terms and content of the Will or Trust is likely to be deceased when questions of authenticity of the document's content arise. For example, Alice who has retired creates a Will which essentially makes Bob (Alice's son), a beneficiary to her assets. Carol who is Alice's daughter finds out about the Will and makes a plan with Eve (secretary of Alice's attorney) to change some of the language specified in the Will. Eve who is an accomplice here makes a change in Alice's will for the beneficiary's name and changes it from Bob to Carol. The simple replacement of the word on the Will has significant legal ramifications. In the presented scenario, this alteration of the beneficiary of the Last Will may go unnoticed for several years. When the questions arise for the integrity of the document's content, Alice may have died. It thus becomes very critical to come up with a method that can prove that this presented document as the Will of Alice is indeed a maliciously modified document and is not the original document. These and other document falsification problems are evident in many legal, academic and commercial settings.

Attempts to build security features into document processes, particularly electronic document processes, typically focus on four areas: confidentiality, party authentication, data integrity and non-repudiation. Confidentiality focuses on ensuring that the data disclosed or transmitted is not seen by any unintended parties. Party authentication in these electronic processes pertains to ensuring that only the intended parties are participating (i.e., each party is, in fact, who they say they are). Data integrity ensures that the data has not changed in transit and that the data has not been altered. Non-repudiation proves that the delivery has taken place for the sender and proof of the sender's identity for the recipient.

Regarding data integrity, various past efforts have involved providing software for comparing data and files, or providing programs such as checksum routines to add up the number of characters, words, and so forth in a document to see if there is a match between compared documents; such efforts have not proven to be very secure.

### SUMMARY OF THE INVENTION

The present invention provides, in part, a solution that keeps printed information secured and provides a system and method for facilitating authentication and data/content integrity verification of printed documents. This solution enhances the value of the existing technology investment in addition to enhancing the traditional methods involved with the authentication of a printed document, such as stamping or signature, for example. The present invention, in part, places emphasis on the capture and conversion of the author's approved content into segment and/or content identifiers upon printing to hardcopy (paper printed form) or conversion to some un-editable, yet readable digital representation, such as digital graphical formats of the document's style and content (e.g. pdf, gif, jpeg or similar digital standards). For purposes of the present application and explanation, the term “printed” or un-editable encompasses hard-copy (paper) representations of the subject document, as well as, other graphical (e.g., digital) representations or formats of documents whose content or data is not intended to be altered.

The present invention further provides, in part, a system and method for facilitating printed page authentication, Unique Segment Identifier and Unique Content Identifier generation and data/content integrity verification once the author has formatted, approved, and converted the content to printed or un-editable hard-copy (e.g., paper) representations of the subject document, as well as, other graphical (e.g., digital) representations or formats of documents whose content or data is not intended to be altered. The present invention can be applied to documents requiring longevity and authenticity, including, but not limited to, academic documents, legal instruments, real estate and loan transactions, Wills and Trusts, and Journal or Historical documents.

In one embodiment, according to the present invention, the author generates the document in any electronic word processing form. When the document is fully proofed and ready for printing and delivery, the approving author initiates the printed page authentication process in accordance with the present invention. After a successful login authentication at the Printed Page Authentication Server (PPAS), the client program—Printed Page Authentication Client (PPAC)—can provide a private salt value, which can consist of random bits or digits. The system then divides the content of the document in multiple segments determined by predetermined segment character intervals, for example, and appends the private salt value to the first content segment and feeds that as an input to a hash function. The latter returns a result called a Unique Segment Identifier (USID) for purposes of the present invention, whose value will be sensitive to the content of the first segment of the document. If additional content segments are available, this process is completed for each. Each segment result for the subject page can be combined in series and re-introduced to the hash function returning a final hash result that becomes the Printed Page Intermediate Identifier (PPII) for the exact content on that page, in one embodiment of the present invention. If a segment length flows to the next page, only that content within the boundaries of the beginning of the segment to the last character on the subject page is used. The following page always starts with a new segment in this embodiment. To achieve the utmost level of security, the Printed Page Intermediate Identifier (PPII) can be subjected to several stringent security measures according to the present invention; these involve adding redundant information to PPII, swapping the positions of elements involved using a transposition cipher, and then applying a secured encryption mechanism to encrypt the generated code to result in the Unique Content Identifier (UCID). The Unique Segment Identifier (USID) and Unique Content Identifier (UCID) can then be printed in some form on the subject page along with the intended formatted printing of the document's content.

It is one function of the present embodiment to print these identifiers in a form resistant to degradation by multiple generations of hard copies (e.g. multiple photocopies or degradation by multiple facsimile transmissions). The Unique Content Identifiers may be printed on the subject page in alpha-numeric, barcode or other printable form available at the time of printing.

If there are images (in addition to alpha-numeric or multi-language text) in the page, the present invention can either ignore such images, or incorporate them in a standardized way. If the document is comprised of character sets for different languages, these can be treated as individual characters. The present embodiment can create Unique Content Identifiers for all languages and character sets used in word processing systems throughout the world.

In one embodiment of the present invention, upon receiving a request to validate the document's content, the present invention can authenticate and verify the integrity of the document's content by reading the presented document's page(s) to reproduce the Unique Content Identifier (UCID). The resulting Unique Content Identifier is then compared to the previously printed content identifier on the subject document. Upon a successful match, the document's page(s) content is considered valid, authenticated and unaltered.

### BRIEF DESCRIPTION OF THE DRAWINGS

FIG. 1 is a schematic diagram of an architecture of one embodiment of the system of the present invention.

FIG. 2 is a flow chart associated with an authentication service in accordance with one aspect of the present invention.

FIG. 3 is an example database schema associated with one embodiment of the present invention.

FIG. 4 is a flow chart indicating processes associated with Printed Page Authentication in accordance with one embodiment of the present invention.

FIGS. 5 and 6 are sample user interfaces in connection with one aspect of the present invention.

FIG. 7 is a sample word and character segmentation in accordance with one aspect of the present invention.

FIGS. 8 and 9 are sample user interfaces in connection with one aspect of the present invention.

FIG. 10 is a sample encoded hash for use in connection with one aspect of the present invention.

FIG. 11 is a sample class hierarchy diagram illustrating the object-owner relationships in accordance with one embodiment of the present invention.

FIG. 12 is a sample user interface in connection with one aspect of the present invention.

### DETAILED DESCRIPTION OF THE PREFERRED EMBODIMENTS

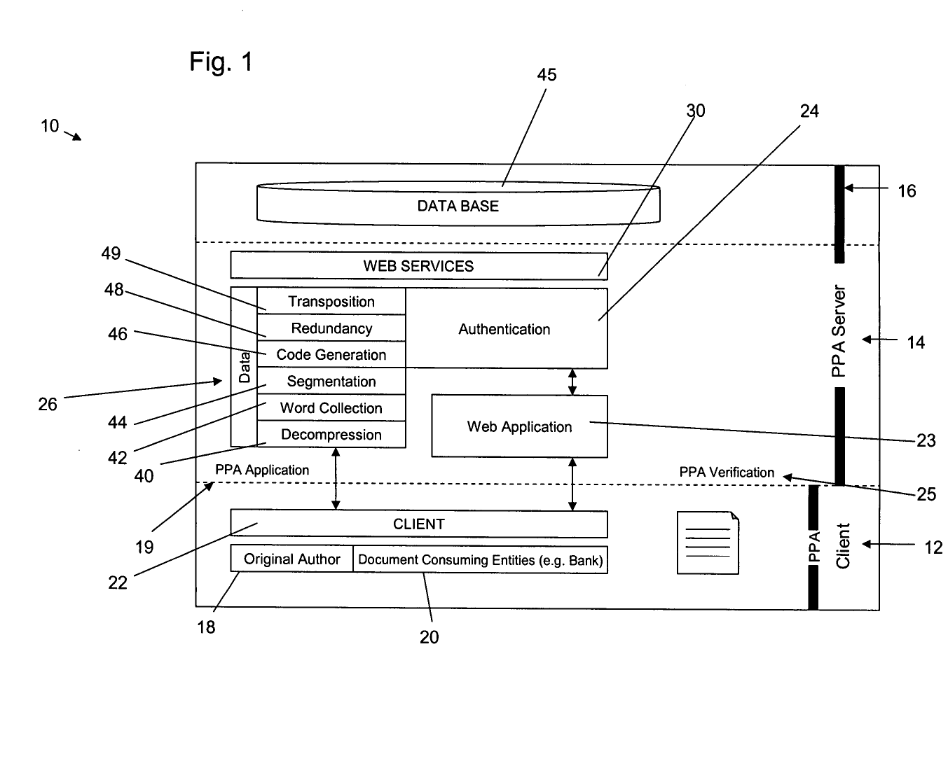

The following describes an overall architecture of one embodiment of the present invention. FIG. 1 illustrates the architecture 10 of Printed Page Authentication (PPA), where three primary components are shown. The client is shown at 12, the server arrangement is shown at 14 and the database is shown at 16. In one embodiment of the invention, the server 14 comprises XML Web Services. Each of these components is explained in more detail below.

### The Client 12

Two types of end user clients are represented in FIG. 1. The first type is the original author 18 of one or more documents who has formatted, approved, and converted the content to printed representations of the subject document. The author uses the process of PPA Application 19 (explained later) to protect himself or herself from a potential malicious modification of the data. For example, author 18 can be an attorney in the legal industry preparing a Last Will, a graduate program director in academia preparing a graduation checklist for a student, or a bank in the finance industry approving a specified loan for a customer. Such authors can use a standalone client implementation associated with the present invention.

The second type of client is the document consuming entity 20. Such entities can include, for example, the group of people who belong to the second, third or later generations for the purposes of using/consuming this document for their specified duties. This group may have the need for verifying the veracity of a document after it has been printed. For example, an attorney 18 who is the original author prepared a legal document for a property. In this case, the bank 20 who is providing the mortgage for the property will become the document consuming entity as the bank may feel the need to verify the legal document received to make sure that it is exactly what the attorney prepared and that the content of this legal document was not modified in a malicious way during its lifetime from creation to the reception by the bank. These clients can utilize the web application of server component 14 for performing PPA Verification 25 described more completely hereinafter.

The client application 22 can be a standalone application or a web application, for example, and is the most visible piece of the present invention because it is the tool through which the end users use the Printed Page Authentication of the present invention. In one embodiment of the present invention, the client application is built using the Microsoft Windows™ Forms classes and the web application. Further details of the client application and its interaction with the remaining components are provided below.

### The Server Component 14

Effectively acting as the primary middle tier, the server component 14 can handle authentication and data requests from any client application that accesses it. In one embodiment of the present invention, an XML Web service 30 is provided which can be segmented into two categories: (1) Authentication 24—where clear text credentials can be submitted to provide login information and can be configured to run under Secure Sockets Layer (SSL), and (2) Data 26—where non-critical data can be sent and received (after some form of authentication) without the overhead of SSL. In one embodiment of the present invention, the Data XML Web services can also be run under SSL to prevent potential attackers from accessing the serialized data.

### Authentication XML Web Service 24

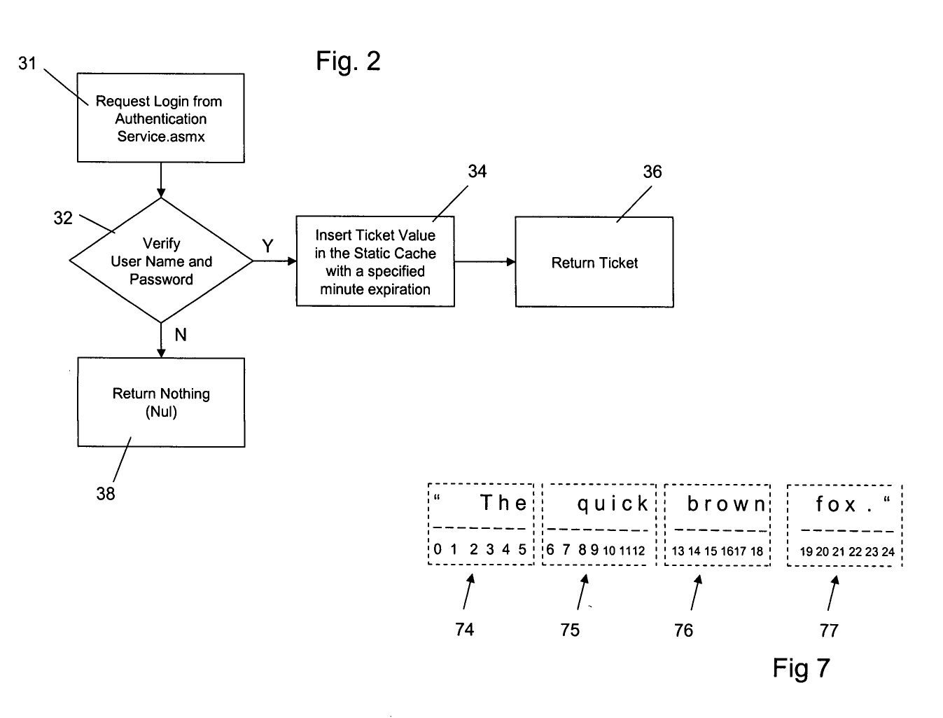

As shown in FIG. 2, the authentication service 24 can work such that, upon receiving a login request from authentication service as at 31, the user's name and password can be validated against the database (using a stored procedure) as at 32. If the name and password are validated, then a unique encrypted ticket can be returned with the user ID embedded as at 36. If the user name and password fail, then nothing is returned as at 38. The value of the ticket can be cached (in the Web application's static cache object, for example) for a predefined timeout limit on the server after it is issued as at 34. This allows the present invention to maintain a server-side list of recently issued tickets that can be accessed by any code running in the same application domain (as demonstrated later by the data service). Because tickets are only maintained in this list for a predefined timeout limit in one embodiment of the invention, client applications are forced to re-authenticate often, which helps to prevent “replay attacks”—situations in which an attacker “sniffs” a ticket off the network and uses it to impersonate the validated user.

### Data XML Web Service 26

Referring again to FIG. 1, the Data XML Web service provides, in part, the functionality for the primary clients to perform Printed Page Authentication on the approved document in accordance with the present invention. Additionally, it allows the document consuming entities to run a verification check on the documents which have been authenticated earlier by PPA in accordance with the present invention. In both cases, the Data XML Web Service 26 is able to validate each request back to a user with the help of the authentication service 24.

In one embodiment of the present invention, every public web method supported by the document service requires the authentication ticket to be passed in with the call. Before any data is returned, the ticket is checked for its existence in the cache. If the ticket exists, the system knows that the user name and password were validated within the last predefined timeout limit duration; otherwise, the ticket is invalid or expired.

The web method provided by the Data Web Service 26 in accordance with the present invention can comprise several modules as shown in FIG. 1. When the original author initiates Printed Page Authentication on any document as at 19, the content of the document is compressed and is sent to the Printed Page Authentication Server (PPAS) 14. When the web method at the Data Web Service on PPAS receives the compressed content, the decompression component 40 decompresses it and passes it to the next layer. In one embodiment of the present invention, the compression is lossless so this decompression module generates the original data without losing any characteristics of the original data.

As further shown in FIG. 1, decompression module 40 presents the original document to the word collection representation module 42. Here, the entire document gets converted into a virtual array of words. This representation facilitates handling of all the formatting details in the text document.

The segmentation component 44 takes the presented array of words and in one embodiment, based on a predetermined word count for a segment, divides the entire document into several segments. For example, if the entire document consists of 1000 words and the predetermined word count for each segment was determined to be 200, then in this case, there will be five such segments created by the segmentation module. In one embodiment of the present invention, this module runs a ceiling function to decide on the segment count. In the previous example, if there are 1049 words in the entire document and the word count for each segment is still 200 words, then there will be a total of six segments for the entire document. The sixth (last) segment will only have 49 words. Segmentation overcomes a major problem associated with the verification of the printed page, as will be explained further below.

A suitable non-colliding hashing function is applied to the presented segment using the code generation component 46. In one implementation of the present invention, a SHA-1 hash is generated. A hash function is an algorithm that transforms a string of characters into a usually shorter value of a fixed length or a key that represents the original value. This is called the hash value. Hash functions are employed in symmetric and asymmetric encryption systems and are used to calculate a fingerprint/imprint of a message or document. When hashing a message, the message is converted into a short bit string—a hash value—and it impossible to re-establish the original message from the hash value. In cryptography, a cryptographic hash function is a hash function with certain additional security properties to make it suitable for use as a primitive in various information security applications, such as authentication and message integrity. A hash function takes a long string (or message) of any length as input and produces a fixed length string as output, sometimes termed a message digest or a digital fingerprint. The generated hash is a unique identifier for the presented segment. To make this hash more secured, the redundancy module 48 can add a level of redundant data to this fixed length hash. The transposition module 50 can complement the additional security provided by the redundancy module by applying a transposition cipher so as to switch one or more characters from the plaintext to another (to decrypt, the reverse is done). That is, the order of the characters is changed.

### Database 16

The database layer in accordance with the architecture 10 of the embodiment of the present invention in FIG. 1 is shown at 16, and the specific database employed is shown at 45. In one implementation of the Printed Page Authentication system of the present invention, the system uses an SQL™ Server database 45 to store all the shared data. This does not include application specific data or configuration settings. In this way, custom applications can be created, each pulling from a single unique data store.

### Database Schema

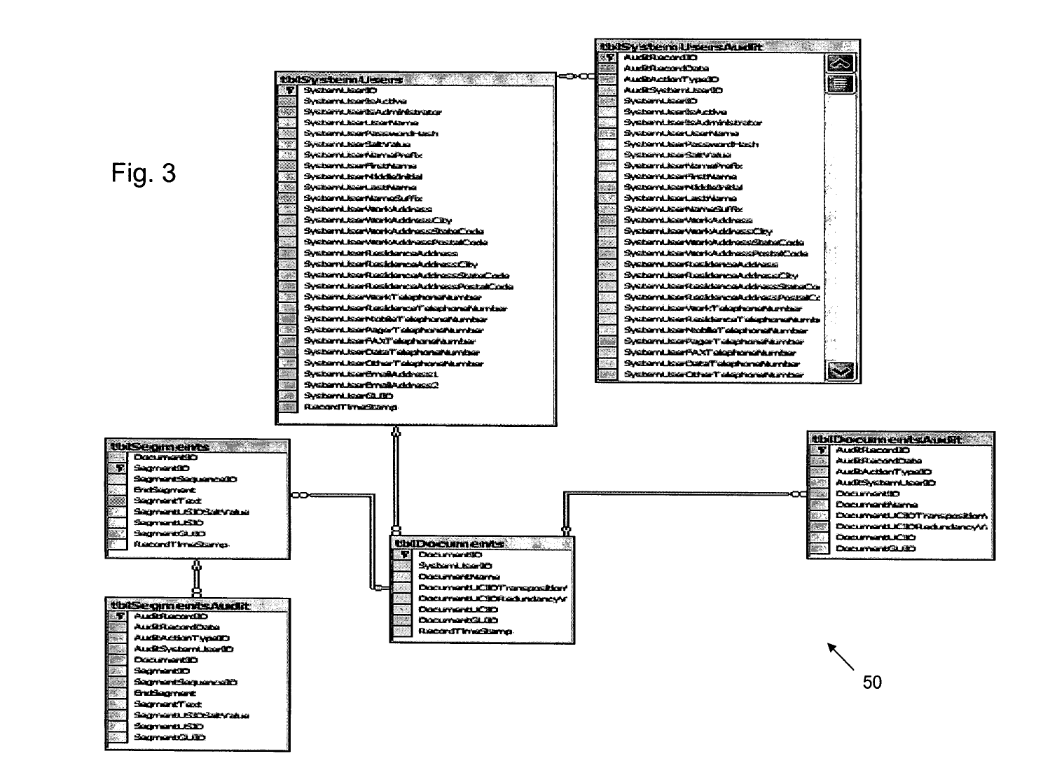

An exemplary PPA database schema in accordance with the present invention is shown at 50 in FIG. 3. The database 45 can be accessed by the XML Web services 30 which only have permissions to run stored procedures on the database. By limiting what the XML Web services can access on the database, the present invention ensures that only appropriate queries are run on the database.

### Stored Procedures

The Printed Page Authentication solution in accordance with the present invention can use stored procedures to encapsulate all of the database queries. Stored procedures provide a clean separation between the database and the middle-tier data access layer. This, in turn, provides easier maintenance, since changes to the database schema will be invisible to the data access components. Using stored procedures can also provide some performance benefits in certain architectural scenarios thanks to caching in the database and the fact that doing some of the processing locally in the database can reduce the number of network requests necessitated.

### Printed Page Authentication-Application

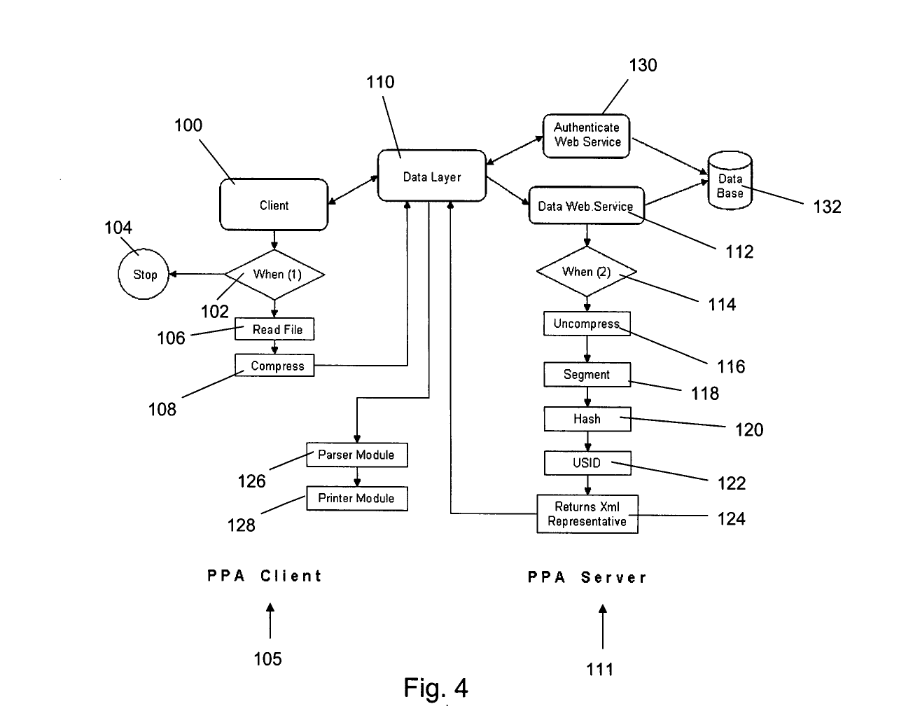

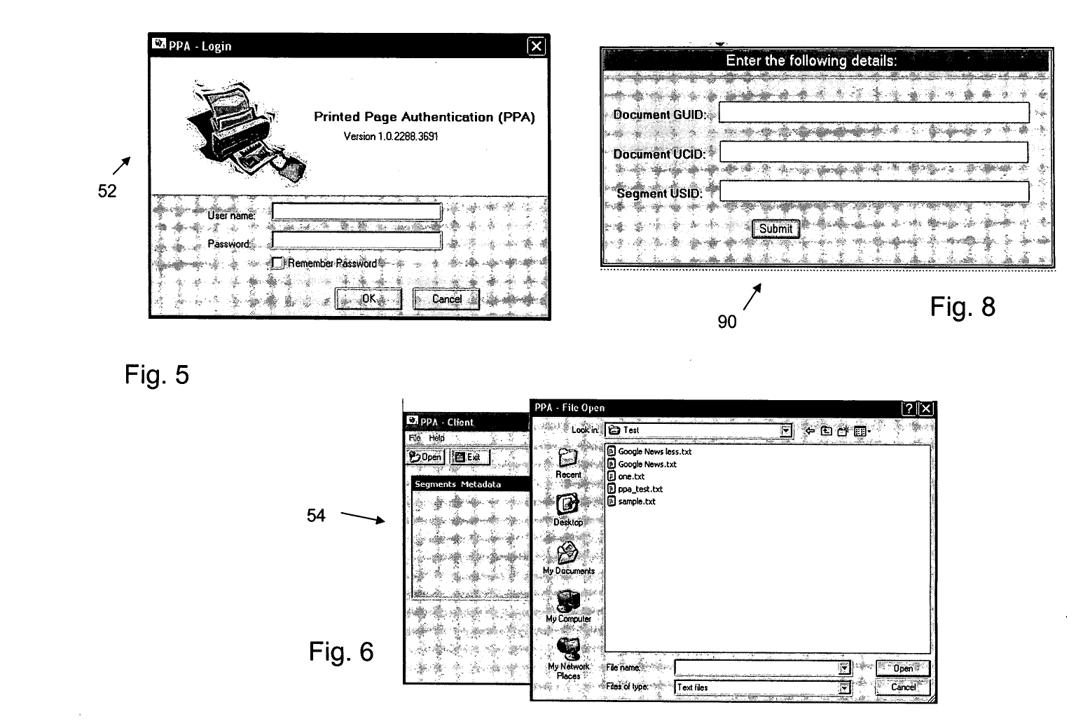

The PPA process in accordance with one embodiment of the present invention is shown in FIG. 4. In the example where an attorney is the original author of a prepared legal document for a property, the attorney decides to run his document through the Printed Page Authentication process in accordance with the present invention.
i) When the document is fully proofed and ready for printing and delivery, the approving author initiates the PPA process by running the client 105 installed on his machine as at 100. After the client loads, as its first step, it presents a Login screen to the original author, such as shown, for example, at 52 in FIG. 5.
ii) Once the original author provides the correct credentials in the form of a valid username and a password, the client authenticates with the Authentication Web Service as explained earlier. The ticket returned by the Authentication Web Service after a successful authentication can be stored in the browser's cache as part of 110 in FIG. 4. For added security, this ticket can be sent to the PPA Server 111 with each subsequent request. In one embodiment of the present invention, any request to the server will be respected and processed only if there is a valid ticket present. In all other scenarios, the user will have to re-authenticate with the server by providing his/her credentials. If the correct credentials are not provided at the preliminary determination step 102, the system will stop as at 104.
iii) At this step, the original author of the document can choose the option to open a file using the menu option on the client. Once the user selects a file in the file open dialog box such as shown at 54 in FIG. 6, the client program starts the round of reading the file from the user's machine as at 106 and once it has read the entire file in the memory, the client will then compress it as at 108 using a lossless compression, for example.
iv) The client program then transmits this compressed data via data layer 110 to the Printed Page Authentication Service 130 as a synchronous web-service call, for example. The web method at the web service accepts the transmitted data after validating the ticket included with the user's request against the information in database 132. At this time, the compressed data is processed by data web service 112.
v) If the ticket is validated at determination step 114, the decompression module of PPA server 111 unzips the compressed data as at 116.
vi) This uncompressed content can then be represented in accordance with the present invention as a virtual array of words by using the word collection module of the present invention. As the present invention is dealing with printed data in this embodiment, there are several challenges that are unique to this domain. One of the biggest problems is the inclusion of formatting while working through this process. In this case, even though textual documents are involved, there is almost always formatting of the text in these documents. This formatting includes all the white spaces, line feed characters, punctuations and other characters that should be preserved. In order to handle this, the present invention can represent each document as a virtual array of words (a word here should at least have one alphanumeric character), as shown at 74 in FIG. 7. In one embodiment, the representation of words is such that:
   a. The first word encompasses all of the preceding non-alphanumeric characters including white spaces shown in FIG. 7 as shown at 74.
   b. All the words except the first word should encompass any preceding non-alphanumeric characters between that word and the word before. For example, the second word should also contain all the alphanumeric characters between the first word and the second word. This is shown in FIG. 7 as at 75 and 76.
   c. The last word should also contain all the following non-alphanumeric characters including white spaces as shown in FIG. 7 at 77.

One of the benefits of this approach is that if it is desired to generate the entire document again with its preserved formatting, one can join all of the words in the array in sequence provided by the index of the array. In this way, one can preserve all of the white spaces and all of the other non-alphanumeric characters.
vii) The next step is the segmentation of the document. The document is segmented into several parts, in part to facilitate the Verification phase in the Printed Page Authentication of the present invention. Once the original author approves the document and runs the document through the Printed Page Authentication process, if there is ever a question about the integrity of the document's content, then a small suspicious segment can be verified using the PPA Verification process explained below. If the document is not segmented, then the entire document would have to be run through this process of verification. If one were to represent the document as a character collection, then to create the segments after every X number of characters in the document would be difficult. This is because, in the document, the word boundary may not coincide with every X number of characters, so most of the segments will then divide one word into two parts based on the character interval specified. To overcome this problem, the present invention represents the document as a word collection as shown in FIG. 7. This way, while creating the segments, the web method can rest assured that its boundaries will never be within a word. Every segment will have a well-defined boundary which will coincide with the semantics of the document instead of simply breaking it apart by characters. These segments form the basic building block of PPA in this aspect of the present invention.
viii) Once a segment is created as at 118 in FIG. 4, a suitable non-colliding hash function can then be applied to the segment as at 120 to generate a fixed size hash of the segment. This effectively makes the identifiers sensitive to the contained data in the segment. In this implementation, the one-way SHA-1 hashing function can be employed. A one-way hash function is an algorithm that generates a fixed string of numbers from a text message. The “one-way” means that it is extremely difficult to turn the fixed string back into the text message. SHA-1 produces a 160-bit digest from a message with a maximum size of 264 bits. The following are some examples of SHA1 digests:
   SHA1 (“The quick brown fox jumps over the lazy dog”)=“2fd4e1c67a2d28fced849ee1bb76e7391b93eb12”
   Even a small change in the message will, with overwhelming probability, result in a completely different hash due to the avalanche effect. A function is said to satisfy the strict avalanche criterion if, whenever a single input bit is complemented, each of the output bits should change with a probability of one half. [6]
   For example, changing d to c:
   SHA1 (“The quick brown fox jumps over the lazy cog”)=“de9f2c7fd25e1b3afad3e85a0bd17d9b100db4b3”
ix) To make the generated hash unintelligible to any entity, redundant data can be added to the generated hash for the segment and a round of transposition cipher can be applied on this augmented data as described above. The ultimately generated identifier is the Unique Segment Identifier (USID) associated with the present invention as shown at 122. This identifier uniquely identifies the associated segment and even with a minor change in the segment, the identifier generated for the modified segment will be drastically different from the original identifier.

Steps vii, viii and ix above are then repeated for each segment of the document. At the end of this process, each such segment in the document will have an associated Unique Segment Identifier (USID). For example, if the original document had 1049 words and the limit for each segment was determined to be 200 words, then six segments would be created by the segmentation process outlined above where the sixth segment has last 49 words. Once the steps viii and ix are performed on each segment in this example, six Unique Segment Identifiers will exist, one corresponding to each segment—USID₁, USID₂, USID₃, USID₄, USID₅ and USID₆.
x) To create an identifier which is unique and sensitive to the entire document, all of the USIDs generated in the previous step can then be appended together in sequence (for example—USID₁USID₂USID₃USID₄USID₅USID₆) and subjected to another round of hash function. Appending different hashes this way and then generating another hash out of it is a method linked to hash list and hash trees. A hash tree is a tree of hashes where the leaves in the tree are hashes of the data blocks in for instance a file or in a set of files. Nodes further up in the tree are the hashes of their respective children.
xi) Redundant data can be added to this concatenation of generated segment hashes as well. Transposition cipher and encryption can also be performed on this hash to make it highly secure. This resulting identifier for the document is called the Unique Document Identifier (UCID).

All these computed results which include the USID for each segment in the document, UCID for the entire document and several other attributes associated with the segment and the document as listed in the database schema presented earlier are stored in the database as persistent data. As illustrated in the database schema, for each segment and for the entire document, a Globally Unique Identifier (GUID) and a record timestamp are stored in the database. A Globally Unique Identifier or GUID can be a pseudo-random number, for example, for purposes of the present invention. While each generated GUID is not guaranteed to be unique, the total number of unique keys (2¹²⁸ or 3.4028×10³⁸) is so large that the possibility of the same number being generated twice is very small. These prove very useful during the PPA Verification process if there is ever a question raised over the integrity of the document's content.

Thus, at this point, at the minimum, the present invention provides the following information:

i) Unique Segment Identifier (USID) for each segment,

ii) Segment Globally Unique Identifier (Segment GUID) for each segment,

iii) Unique Document Identifier (UCID) for the entire document,

iv) Document Globally Unique Identifier (Document GUID) for the entire document.

### These generated results with the other attributes can then be represented as an xml string whose format looks like the sample for two segments illustrated below.

<?xml version=”1.0” encoding=”utf-8”?>

| | |
|---|---|
| <document | documentID=”211” documentName=”” |
| | documentUCIDTranspositionValue=”0” |
| | documentUCIDRedundancyValue=”” |
| | documentUCID= |
| | ”D1219E9D86EFAEB441C00E2733F9F4BEF6149FE5” |
| | documentGUID=”2c483d0e-5cea-4d49-976e- |
| | 616b746aebf2”> |

```
    <segments count=”2”>
        <segment>
```

<documentID>211</documentID>
<segmentID>628</segmentID>
<segmentSequenceID>0</segmentSequenceID>
<endSegment>False</endSegment>
<segmentUSIDSaltValue></segmentUSIDSaltValue>
<segmentUSID>
056A80E5E6070A003DF3AA5F35A185F4857E8D02
</segmentUSID>
<segmentGUID>9e0f4aae-c6f4-4c28-9d05-
bcbbe7808d56</segmentGUID>

```
        </segment>
        <segment>
```

<documentID>211</documentID>
<segmentID>629</segmentID>
<segmentSequenceID>1</segmentSequenceID>
<endSegment>False</endSegment>
<segmentUSIDSaltValue></segmentUSIDSaltValue>
<segmentUSID>
5DF18C4E2F158319C22390ACEE0D231B6A6BA7A9
</segmentUSID>
<segmentGUID>09bf3d39-921b-4aa0-a17d-
b8f574c45a8b</segmentGUID>

```
        </segment>
    </segments>
</document>
```

This well-defined xml is then returned to the client by the Data Web Service as at 124 in FIG. 4. When the client had initiated the PPA application process, the subject file was read in the memory before it was sent to the Data Web Service. On the receipt of the xml from the Data Web Service, the client parses it for the segment and the document identifiers along with the other attributes as at 126. The Document GUID and the document UCID are then inserted to the beginning of this file in memory. A special parser routine within the client will then extract each Segment USID from the received xml and add that string to the appropriate word in the word representation of the document. For example, if the xml had returned six USIDs as there were 1049 words and six segments as in our earlier example, then the parser routine will add the first segment USID to the 200^{th} word in the document. The second segment USID will be appended to the 400^{th} word in the document and so on. These extracted identifiers may be printed on the subject page in an alphanumeric, barcode or other printable form available at the time of printing as at 128. Upon receiving a request to validate the document's content, the present invention can authenticate and verify the integrity of the document by reading the presented document and segment identifiers to reproduce the original document's segment in question.

The modified document can now be printed directly to the printer connected to the computer. To overcome the problem of any possible modifications to the document, and in one embodiment of the invention, no electronic representation of the document authenticated with PPA is stored on the client's machine. PPA client will directly print to the printer once the xml returned from the Data Web Service is parsed and added to the appropriate words in the original document. The process of PPA Application is now complete and the document is said to be authenticated by Printed Page Authentication.

### Printed Page Authentication-Verification

When there is a question raised about the authenticity of the document's content, the present invention turns to Printed Page Authentication Verification (PPAV).

Let us consider our previous example where an attorney who is the original author prepared a legal document for a property. The attorney's client presents this document to his bank that is providing the mortgage for the property this client is interested in. The client and the bank in this case are the document consuming entities as explained earlier. The client may be satisfied with the attorney's service but the bank may feel the need to verify the legal document received to make sure that it is exactly what the attorney prepared and that the content of this legal document were not modified in a malicious way during its lifetime from creation to the reception by the bank. For instance, after the attorney created and approved the document, he handed it to his secretary to pass its copy to the attorney's client. The secretary in this case turned out to be dishonest and she figured out a way in which she could defraud the attorney's client by changing some terms in the legal document's copy originally prepared by the attorney. When the bank gets this document and assuming that the attorney had not authenticated it by using Printed Page Authentication, the only method in which the bank can find out whether the document is indeed correct is by comparing the original document with the document that the bank received. By doing this intense effort in comparing the two documents manually or by using a document comparison program, the bank may find out that the document is not the correct one and that some data has been modified in this document. The bank points the finger towards the attorney who is the original author of the document. Presently, there is no way in which the attorney can protect himself in such a scenario.

Instead, let us consider the scenario where the attorney (original author) had performed a Printed Page Authentication-Application, as explained earlier, on this legal document. If the bank ever raises a question on the veracity of the document's content, the document consuming entity (here, the bank) can use the Printed Page Authentication-Verification service for that purpose. In this process, the bank will open up the Printed Page Authentication Web Application Client using a login interface as is known in the art. In the Internet/web application embodiment of the present invention, anyone with valid credentials can logon to the verification service provided by Printed Page Authentication.

After successful authentication, the document consuming entity can follow either of the following approaches to make a faster decision on whether the document is correct or not.

### Verification Using Just the Identifiers

In this approach, the identifiers printed on the document when the PPA-Application was performed can be used. A user interface 90 can be provided as shown in FIG. 8, for example, whereby the user can enter a Document GUID, Document UCID and Segment USID in order to verify particular segments of the printed document.

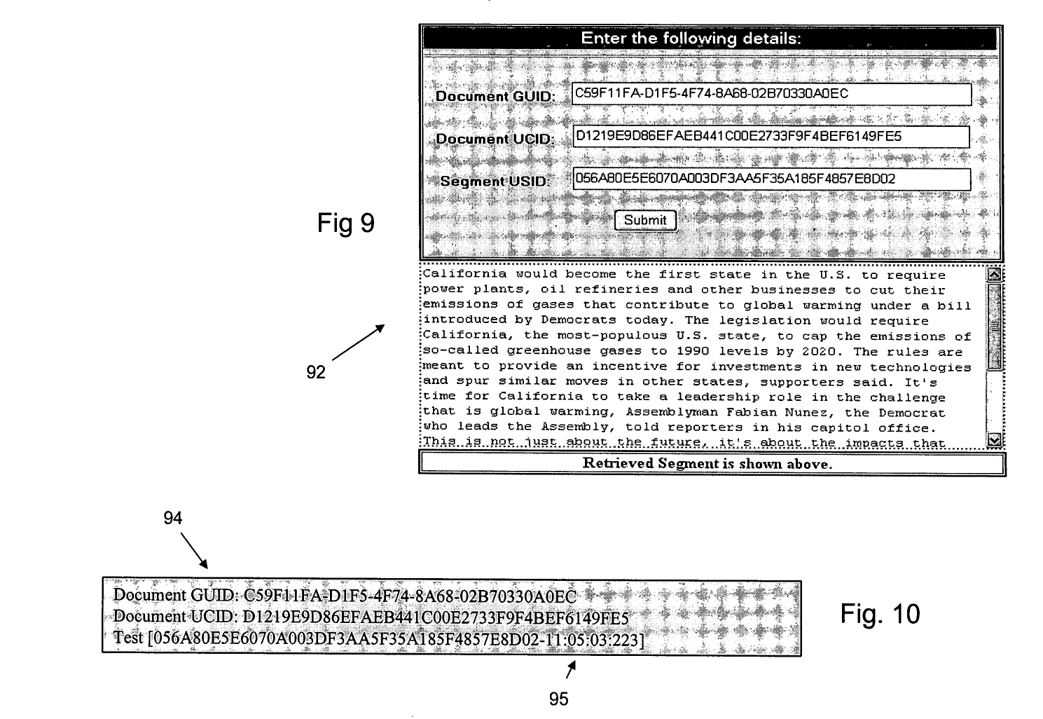

As the document has been PPA certified by the original author, the Document GUID and the Document UCID are both printed on the document. Also, after every segment defined by the predetermined word count, there will be a Segment USID. If the Segment Identifiers were initially printed as barcodes on the printed document, then the barcodes optionally may have also been used to encompass the segment's text along with the Segment USID, or it can be just the Segment USID that was printed at the end of each segment. This method allows the document consuming entity to just check the segment they think has a problem or that they suspect has been modified. In the interface as shown in FIG. 8, when all of the three identifiers have been entered successfully, the Printed Page Authentication Server will reveal the corresponding segment's text to the document consuming entity as shown at 92 in FIG. 9. It will be appreciated that, in one embodiment of the present invention, GUID can have 2¹²⁸ combinations and SHA-1 hashes can have 2⁶⁴ sizes. To ensure security in one embodiment of the present invention, all three identifiers are required and the format for the identifiers must be entered exactly as it is printed on the PPA certified document. In alternative embodiments, the present invention can allow for validation with only two of the identifiers. It is presumed that guessing all three identifiers is statistically impossible. Also, even if a third party (e.g., office manager) has physical access to the document and thus all three numbers, all he/she can do is reveal the document's segment. As described below, other methods in accordance with the present invention can help undermine any attempts made by a third party to dupe the PPA system in any way.

### Verification Using the Segment's Content

In this approach, the entire segment text printed on the document when the PPA-Application was performed will be used. Again, if the barcode printing was used initially, the entire segment may optionally have been encoded in a small barcode. This alleviates the burden of re-keying the entire segment during the verification process. Once the entire segment data has been provided, PPA-Verification service can compare the USID value generated for this segment with the USID value stored for the corresponding segment of the original document.

Thus, by following any of the above approaches, the document consuming entity or the original author can validate the document's content. In the case when the document consuming entity does not verify the data using PPA Verification Service and directly points to the original author on discovering that the data is incorrect, PPA Verification Service can be successfully used by the original author to protect himself/herself

### Dishonest Original Author Problem

Let us say for example, the original author created and approved a document. This document is the correct legal document. The author then applied Printed Page Authentication-Application on this document. Thus, the document was PPA certified with the Document GUID, Document UCID and the Segment USIDs embedded in the document. Now, it turns out that the original author himself/herself is dishonest. He/she changes something in this PPA certified document. After making the change to the text in the document, he/she leaves the identifiers unchanged in the document. He then passes this document on to his/her secretary who is honest in this case. The secretary honestly passes this document to the other entity, in this case, the bank. The bank feels a need to verify the document's content. If the bank follows any of the two approaches mentioned for the PPA Verification service in the previous section, the latter will notify the bank that the document with the bank is indeed invalid and is different from what was submitted by the original author for PPA Application. When the bank points the finger towards the original author, the latter can use PPA Application as an alibi. He/she can say that he did a PPA on the original document and those results are stored with the Printed Page Authentication Server. In this case, the original author himself/herself is dishonest and is trying to use PPA to deliberately introduce an error in the document.

In one embodiment, the present invention can assist in solving the above problem as follows:

After the PPAC (PPA Client) receives the xml response back from the PPAS (PPA Server) as shown in FIG. 4, and the client inserts the identifiers in the original document, PPAC can directly print the PPA certified document. No electronic representation for the document is stored locally on the client's machine in this embodiment. Also, to resolve the problem completely, a segment record timestamp provided by the PPAS can be printed after predetermined transposition with every segment identifier. This way, if the author tries to replace a PPA certified segment with a different incorrect segment, the transposed timestamp printed can be used to determine if that is exact segment that was submitted by the original author when PPA was performed on the document. Here is an example:

Author A created a document which has only one word “test”. He wants to perform a PPA-Application on this. When he performs the PPA application, the PPA client inserted the entry 94 to the document as shown in FIG. 10. As shown at 95 in FIG. 10, 11:05:03:223 is the transposed timestamp when the original author had submitted this document for Printed Page Authentication. In one embodiment, the present invention can print the record timestamp only after performing a transposition on it so that the original author cannot directly change the time to the old value to cheat the system. For example, suppose, the original timestamp stored for the segment in the database is 04:04:23:243.

Now, Author A is dishonest and he wants to use the PPA system as an alibi when a question is raised about the validity of the document. He changes the word “test” in the document to “best”, and leaves the identifiers and the timestamp without any making any modifications. When the bank gets this document and the verification process attempted by the bank fails, the bank comes back to the author A and tells him that his document is invalid. Author A claims that he did a PPA on the document and thus it is some other entity between author A and the bank who changed the document. The bank can then contact the PPAS in these special circumstances to find out what segment was submitted to PPA at the time printed on the PPA certified segment. PPA comes back reporting that the document that was submitted at the specified time was indeed “test” and thus the original author tried to cheat the system.

One of the alternatives to the above mentioned approach occurs when, instead of printing the timestamp on the document for each segment, a special PPA watermark is printed by the PPA Client on every document that is subjected to PPA-Application. This watermark or the image should be something that can only be generated by the PPA client after PPA has been performed for that document. This way, if the author tries to print out another page to replace one of the pages in PPA certified document, the author is unable to reproduce the PPA Certified symbol on this newly printed page. Using either approach, the problem of original author being dishonest is thus solved in a feasible manner.

The present invention can be developed using appropriate computer programming that allows for two types of clients as identified above, the standalone client and the web application client.

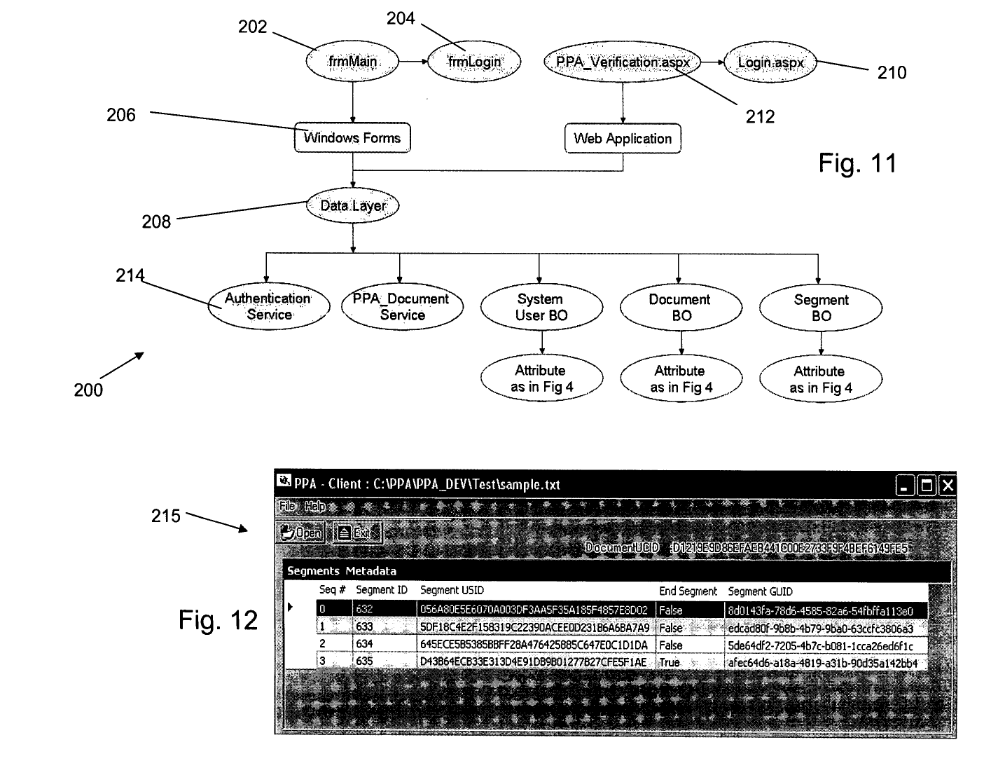

Standalone client essentially has two important forms:
i) frmLogin—This form is shown in FIG. 5 and is represented at 202 in the object-owner relationships in the PPA class hierarchy diagram 200 of FIG. 11. The Login form authenticates the user name and password provided by the user and prevents unauthorized users from updating the database via the data XML Web services. The user name and password are sent through the DataLayer object to the authentication XML Web service for validation. Provided the credentials are authenticated and the user checked the “Remember Password” CheckBox, the user name and password, which is encrypted using the Windows 2000/XP Data Protection API (DPAPI), are saved to the registry so the user will not have to re-enter them upon future log-ins. Implementation Details: The Login form (as with most classes derived from the System.Windows.Forms.Form class) can be displayed by instantiating an object and calling a “ShowDialog” method as is known in the art. However, the default constructor can be changed to require the DataLayer object 208 as a parameter.
ii) frmMain—This form is shown in FIG. 6 and at 204 in FIG. 11. The Main form sets the foundation for the event driven application of the present invention and, in some respects, is the core of the user experience. Three major areas of concern for the Main Form are Form UI Initialization, Form Load and Event Handling. As with all Windows™ Forms 206, the designer UI initialization occurs within the constructor of the Main form. The method InitializeComponent instantiates the UI controls and sets the necessary properties required to render the controls. Generally speaking, InitializeComponent is called before custom code within the constructor.

When the original author wants to perform PPA Application on a document stored on his/her machine, the user can use the Open Button on the toolbar to open the File Open Dialog Box. When the user selects a file within this form, it essentially initiates the PPA process. The entire file is then read in the memory by the client. After a round of lossless compression, the file's content is transmitted to the Data Web Service via an asynchronous call to the exposed web method. The frmMain then waits for the web service call to return. When the xml is returned by the PPA Server corresponding to the file, frmMain updates the data grid within the form to display the operation's progress as shown at 215 in FIG. 12.

Similarly to standalone client, Web application client has two main forms:
i) Login.aspx—This is the default page of the web-application for performing PPA Verification as illustrated at 210 in FIG. 11. This form performs the same function as that performed by the frmLogin on the standalone client application.
ii) PPA_Verification.aspx—This form is represented at 212 in FIG. 11. This form presents the Document GUID, Document UCID and Segment USID. Required validations and format validations are applied to the inputs provided. If the input meets the entire valid criterion, then the corresponding segment is retrieved from the database and shown to the user on this form.
   The next component shown in the class hierarchy (FIG. 11) is the DataLayer 208. In one embodiment of the present invention, the DataLayer class is the XML Web services wrapper and data manager for our client application. All working data that is retrieved from database and used in the application belongs to the DataLayer class providing the application a single reference to access data. All the information retrieved from the XML Web services are owned by the DataLayer class. The data is accessible through public members of the DataLayer class and the various UI forms are free to read and change this local data. The act of updating or retrieving data from the XML Web services can only be accomplished by using public methods in the DataLayer class. The DataLayer class was designed to be used in a single threaded environment, and by calling these methods on the main thread, the present invention can ensure that information retrieved from the XML Web service calls is properly merged into our local data synchronously and that our data bound UI controls do not refresh their graphics on a background thread.

Most of the public methods follow a similar design: request (or send) the data with the current authentication ticket from (or to) the Data XML Web service, re-authenticate and handle any exceptions if necessary, merge any returned data, and then return a DataLayerResult back to the calling code to indicate the success or failure of the operation.

Implementation Details: The DataLayer class is designed to manage data and provide access to the XML Web service functionality for the entire application in a single threaded environment. Once instantiated by the Main form, the DataLayer object remains in memory during the application session and is passed to new application objects as needed.

### Authentication XML Web Service

The authentication XML Web service 214 contains several methods that client applications can use to authenticate a user and retrieve user information. The authentication service works on very simple principle: validate the user name and password against the database (using a stored procedure), and then return a unique encrypted ticket with the user ID embedded. If the user name and password fail then nothing is returned. The authentication XML Web service can be accessed by the PPA client application by adding a Web Reference to the XML Web services URL in the PPA Visual Studio™ .NET project. This creates a client-side proxy for the XML Web service which can then be handled in code like any local object, calling its public methods as needed.

The Data XML Web service contains several methods that client applications can use to retrieve the xml containing the identifiers used for the PPA solution. The Data XML Web service with the help of the authentication service is able to validate each request back to a user. Every public method in the data XML Web service requires a ticket before returning or processing any data. If the ticket exists, we logically know that the user name and password were validated within the predefined timeout limit. The Data XML Web service can be accessed by the PPA client application by adding a Web Reference to the XML Web services URL in the PPA Visual Studio™ .NET project. This creates a client-side proxy for the XML Web service which can then be handled in code like any local object, calling its public methods as needed.

The SystemUserBusinessObject provides an object representation for a System User within the application. The DocumentBusinessObject provides an object representation for a Document within the application. Each document processed by the PPA application can be represented by using a DocumentBusinessObject. Segmentation module of the Data XML Web Service creates segments for any document under PPA processing. The SegmentBusinessObject provides an object representation for each such segment within the application.

If there are images (as opposed to words) on the page, the system of the present invention can either ignore such images, or handle them in a standardized way. In one of the embodiments, once each page or pre-determined segment has been parsed and UCIDs created for each page, the entirety of UCIDs can be appended together to generate a Printed Page Document Identifier (PPDID). PPDID can be stored in database 25 and/or communicated to another party such as the requester in accordance with the present invention for later use. It will be appreciated that a complete PPDID as well as individual UCID's and USID's can be stored, such that an entire document as well as pre-determined pages/segments can have individually associated codes. In this way, pages/segments of documents can be authenticated by the present invention just as easily as entire documents.

In one embodiment of the present invention, the UCID and PPDID can be bar-coded, such as using PDF 417 two-dimensional or three-dimensional bar coding. Also, it will be appreciated that one can hash the message whether it has been encrypted or not, in addition to hashing the message digest itself.

It will further be appreciated that the hash function or algorithm cannot be derived from the hash codes or values. The hash function in accordance with the present invention can be sophisticated enough to avoid or provide a low risk of collision—whereby two different inputs can create the same hash value.

Once requester has completed the Printed Page Authentication process, requester can provide the document to recipient. If recipient incorporates changes, recipient can return the document with the requested changes to respective requester, for submission to the Printed Page Authentication Process. Printed Page Authentication will then re-generate the USID for the pre-determined segments, UCID for individual page and PPDID for the document as described above, for the requester. Once the document is deemed acceptable to recipient and/or requester, it becomes the standard document against which future comparisons are made.

Upon receiving a request to authenticate the integrity of the document later, in one of the embodiments, the present invention can authenticate the document by reading the presented document to generate the new Unique Content Identifier or the Printed Page Document Identifier, and comparing them against the originally published UCID from the document's page or PPDID for the entire document. Upon a successful match, the document is considered valid and authenticated. Authentication and/or data integrity verification can occur via provider, who can be provided with an authentication/integrity component for this purpose. Alternatively, requester can be provided with an authentication/integrity component such that requester need not contact provider for this service.

The present invention can be applied to legal relationships such as contracts for goods and services, international trade and finance, and any other applications where document authentication, data integrity verification and non-repudiation are involved.

The present invention can be implemented in one embodiment such that a user interface such as provided to document consuming entities 20 can access a document order processing system and components as part of web application 23, for example. The system includes an order receiving and processing component that can receive the consuming entity's request for a document order. The document being ordered can be one that is capable of automatic integrity verification per the methods described above. The system can implement the document processing steps illustrated above for Printed Page Authentication-Application as part of a document processing component associated with server 14 and/or web application 23. The system can further access and implement the document authentication steps and techniques above for Printed Page Authentication as part of an authentication component associated with server 14 and/or web application 23. The authentication component can, as described above, automatically and without manual processing, segment the requested document into two or more pre-determined segments, apply a hashing function on at least the segments and develop a hash code corresponding to each of the pre-determined segments of the prepared document, combine the hash codes for each of the pre-determined segments into a bulk document code and print the document with the bulk document code and at least one of the segment hash codes printed thereon. The system can further provide a document transmitting component associated with server 14 and/or web application 23 for transmitting a prepared, authenticated legal document to a requester.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A method for preventing document falsification, comprising the steps of:
receiving a document capable of electronic representation;
electronically converting the document into a virtual array of words including non alpha-numeric characters;
automatically and without manual processing, segmenting said document into two or more pre-determined segments;
applying a hashing function on at least two of the segments and developing a hash code corresponding to each of the at least two segments of said document;
combining said hash codes for each of the pre-determined segments into a bulk document code; and
printing said document with the bulk document code and at least one of said segment hash codes printed thereon.

2. The method of claim 1 wherein said pre-determined segments have a given word length.

3. The method of claim 1 wherein said document is compressed using lossless compression and transmitted to a data web service for decompression.

4. The method of claim 1 including the further step of printing said hash codes for each of said pre-determined segments on the document.

5. The method of claim 4 wherein each pre-determined segment hash code is printed at the end of its respective segment.

6. The method of claim 1 including the step of determining a pseudo-random Global Unique Identification (GUID) code and printing the GUID on the document as part of the printing step.

7. The method of claim 6 including the step of verifying the integrity of one or more segments of the document by reading the segment hash code identifier for the one or more segments and the GUID to reproduce the one or more segments from the original document.

8. The method of claim 7 including the further step of manually comparing the wording from the reproduced segment with the wording from the original segment on the printed document.

9. The method of claim 7 including the further step of automatically comparing the wording from the reproduced segment with the wording from the original segment on the printed document using a document comparison program.

10. The method of claim 7 including the further step of generating a new hash code from the reproduced segment using the hashing function and comparing the generated new hash code with the hash code for the printed document.

11. The method of claim 1 wherein the bulk document code includes redundant data and further including the step of executing a transposition cipher against the modified bulk document code to create a Unique Content Identifier (UCID).

12. The method of claim 1 including the further steps of receiving, by a requester, a request to provide a document capable of automatic content integrity verification.

13. A document order processing and authentication system, comprising:
an order receiving component for receiving at least one order for a legal document from a requester;
a document processing component for arranging the preparation of said legal document, and representing the document electronically as a virtual array of words including non alpha-numeric characters;
an authentication component for:
automatically and without manual processing, segmenting said document into two or more pre-determined segments;
applying a hashing function on at least two of the segments and developing a hash code corresponding to each of the at least two segments of said document;
combining said hash codes for each of the pre-determined segments into a bulk document code; and
printing said document with the bulk document code and at least one of said segment hash codes printed thereon; and
a transmission component for transmitting a prepared, authenticated legal document to said requester.

14. The system of claim 13 wherein said document processing component can access an affiliate document provider via a network communication in arranging for the preparation of said legal document.

15. A method for processing document orders and verifying the authenticity of executed versions of said ordered documents, comprising the steps of:
providing an order receiving component for receiving at least one order for a legal document from a requester;
providing a document processing component for arranging the preparation of said legal document, representing the document electronically as a virtual array of words including non alpha-numeric characters;
providing an authentication component for:
automatically and without manual processing, segmenting said document into two or more pre-determined segments;
applying a hashing function on at least the segments and developing a hash code corresponding to each of the pre-determined segments of said prepared document;
combining said hash codes for each of the pre-determined segments into a bulk document code; and
printing said document with the bulk document code and at least one of said segment hash codes printed thereon; and
providing a transmission component for transmitting a prepared, authenticated legal document to said requester.

16. A system for managing the data integrity verification of legal documents, comprising:
means for ordering a legal document from a document order processing system;
means for receiving, from said order processing system, the ordered legal document, a first code (Segment USID) representative of at least one segment of the conveyed text within said legal document and a second code representative of a combination of document segment codes (UCID); and
means for comparing at least a segment of an executed version of the legal document with the original ordered legal document by receiving, from an end user, the first code and the second code.

17. The system of claim 16 wherein the means for receiving includes means for receiving a document Globally Unique Identifier (GUID) and wherein the means for comparing includes receiving, from the end user, the GUID.

18. A method for preventing real estate settlement document falsification, comprising the steps of:
receiving a request from a requester to provide a real estate settlement document;
preparing said document, including issuing a private salt value for one or more pre-determined segments of said document or the full document and appending the salt value to a document segment;
applying a hashing function on at least the one or more segments and developing a hash code corresponding to each of one or more pre-determined segments of said prepared document, wherein the step of developing the hash code incorporates the private salt value;
adding redundant data to each hash code;
transposing selected hash value elements of one or more of said hash codes;
combining said hash codes for each of said pre-determined segments into a bulk document code; and
printing said document with the bulk document code and at least one of said segment hash codes printed thereon.

19. The method of claim 18 wherein said pre-determined segments have a given word length.

20. The method of claim 18 wherein, upon being prepared, said document is compressed using lossless compression and transmitted to a data web service for decompression.

21. The method of claim 18 including the further step of printing said hash codes for each of said pre-determined segments on the document.

22. The method of claim 21 wherein each pre-determined segment hash code is printed at the end of its respective segment.

23. The method of claim 18 including the step of determining a pseudo-random Global Unique Identification (GUID) code and printing the GUID on the document as part of the printing step.

24. The method of claim 23 including the step of verifying the integrity of one or more segments of the document by reading the segment hash code identifier for the one or more segments and the GUID to reproduce the one or more segments from the original document.

25. The method of claim 24 including the further step of manually comparing the wording from the reproduced segment with the wording from the original segment on the printed document.

26. The method of claim 24 including the further step of automatically comparing the wording from the reproduced segment with the wording from the original segment on the printed document using a document comparison program.

27. The method of claim 24 including the further step of generating a new hash code from the reproduced segment using the hashing function and comparing the generated new hash code with the hash code for the printed document.

28. The method of claim 18 including the further steps of receiving, by the requester, the printed document.

29. A document order processing and verification system, comprising:
an order receiving component for receiving at least one order for a legal document from a requester;
a document processing component for arranging the preparation of said legal document;
a document authentication component for deriving one or more codes associated with said legal document, wherein deriving the one or more codes includes:
issuing a private salt value for one or more pre-determined segments of said document and appending the salt value to the document segment;
applying a hashing function on at least the one or more segments and developing a hash code corresponding to each of one or more pre-determined segments of said prepared document, wherein the step of developing the hash code incorporates the private salt value;
adding redundant data to each hash code; and
transposing selected hash value elements of one or more of said hash codes; and
printing the document with at least one of said codes printed thereon; and
a document integrity verification component enabling verification of the integrity of the printed document by receiving, from an end user, at least one of the codes.

30. The system of claim 29 wherein said document processing component can access an affiliate document provider via a network communication in arranging for the preparation of said legal document.

31. A method for processing document orders and verifying the authenticity of executed versions of said ordered documents, comprising the steps of:
providing an order receiving component for receiving at least one order for a legal document from a requester;
providing a document processing component for arranging the preparation of said legal document;
providing a document authentication component for deriving one or more codes associated with said legal document, wherein deriving the one or more codes includes:
issuing a private salt value for one or more predetermined segments of said document and appending the salt value to the document segment;
applying a hashing function on at least the one or more segments and developing a hash code corresponding to each of one or more predetermined segments of said prepared document, wherein the step of developing the hash code incorporates the private salt value;
adding redundant data to each hash code; and
transposing selected hash value elements of one or more of said hash codes; and
printing the document with at least one of said codes printed thereon; and
providing a document integrity verification component enabling verification of the integrity of the printed document by receiving, from an end user, at least one of the codes.

32. A method for authenticating documents, comprising the steps of:
preparing a document, including representing the document electronically as a virtual array of words including non alpha-numeric characters and automatically and without manual processing, segmenting said document into two or more pre-determined segments, the pre-determined segments being based on words and not characters;
executing a hashing function on the prepared document and developing a bash code corresponding to each of the pre-determined segments of said prepared document;
combining said bash codes for each of the pre-determined segments into a bulk document code;
adding redundant data to the bulk document code;
executing a transposition cipher against the bulk code with redundant data to derive a Unique Document Identifier (UCID) for the prepared document; and
printing said document with the hash codes, bulk document code and UCID printed thereon.

33. The method of claim 32 including the step of verifying the integrity of one or more segments of the prepared document without storing or transmitting the document electronically.

34. The method of claim 33 wherein the step of verifying the integrity of one or more segments of the document includes reading the segment hash code identifier for the one or more segments, the bulk document code and the UCID to reproduce the one or more segments from the original document.

35. The method of claim 33 wherein the step of verifying the integrity of one or more segments includes the further step of manually comparing the wording from the reproduced segment with the wording from the original segment on the printed document.

36. The method of claim 33 wherein the step of verifying the integrity of one or more segments includes the further step of automatically comparing the wording from the reproduced segment with the wording from the original segment on the printed document using a document comparison program.

37. The method of claim 33 wherein the step of verifying the integrity of one or more segments includes the further step of generating a new hash code from the reproduced segment using the hashing function and comparing the generated new hash code with the hash code for the printed document.
